(19) United States
(12) Patent Application Publication
(10) Pub. No.: US 2025/0147269 A1
(43) Pub. Date: May 8, 2025

(54) DRIVING MECHANISM

(71) Applicant: TDK TAIWAN CORP., Taoyuan City (TW)

(72) Inventors: Wei-Jhe SHEN, Taoyuan City (TW); Kun-Shih LIN, Taoyuan City (TW); Chen-Hung CHAO, Taoyuan City (TW); De Shiang CHEN, Taoyuan City (TW); Sin-Jhong SONG, Taoyuan City (TW)

(21) Appl. No.: 18/937,458

(22) Filed: Nov. 5, 2024

(30) Foreign Application Priority Data
Nov. 8, 2023 (CN) 202311481505.X

(51) Int. Cl. G02B 7/09; G02B 27/64

(52) U.S. Cl. CPC G02B 7/09; G02B 27/646

(57) ABSTRACT

A driving mechanism for moving an optical element is provided. The driving mechanism includes a fixed part, a movable part, and a driving assembly. The movable part is movably connected to the fixed part for holding the optical element. The driving assembly is configured for moving the movable part relative to the fixed part.

### CROSS REFERENCE TO RELATED APPLICATIONS

This application claims priority of China Patent Application No. 202311481505.X, filed on Nov. 8, 2023, the entirety of which is incorporated by reference herein.

### BACKGROUND OF THE INVENTION

### Field of the Invention

The present invention relates to a driving mechanism, and, in particular, to a driving mechanism for moving an optical element.

### Description of the Related Art

As technology has advanced, a lot of electronic devices (for example, laptop computers and smartphones) have incorporated the functionality of taking photographs and recording video. These electronic devices have become more commonplace, and have been developed to be more convenient and thin. More and more options are provided for users to choose from.

In some electronic devices, several coils and magnets corresponding thereto are usually used for adjusting the focus of a lens. However, miniaturization of these electronic devices may increase the difficulty of mechanical design, and it may also lead to low reliability and low driving force for moving the lens. Therefore, addressing the aforementioned problems has become a challenge.

### BRIEF SUMMARY OF THE INVENTION

An embodiment of the present invention provides a driving mechanism for moving an optical element that has an optical axis. The driving mechanism includes a fixed part, a movable part, and a driving assembly. The movable part is movably connected to the fixed part for holding the optical element. The driving assembly is configured for moving the movable part relative to the fixed part.

In some embodiments, the driving mechanism further includes a plurality of conductive members and a grounding member, wherein the fixed part includes a housing and a base connected to each other, the conductive members and the grounding member are embedded in the base, and the grounding member is electrically connected to the housing.

In some embodiments, the conductive members and the grounding member are embedded in the base by insert molding.

In some embodiments, the driving mechanism further includes a lower sheet spring movably connecting the base to the movable part, wherein at least one of the conductive members forms a flat portion that is exposed to the top side of the base and electrically connected to the lower sheet spring, and the flat portion is higher than the grounding member.

In some embodiments, the base has a plurality of columns extending along the optical axis, and the movable part has a bobbin extending in a direction perpendicular to the optical axis and located between the columns.

In some embodiments, the driving mechanism further includes a circuit assembly disposed on the base, wherein the conductive members are directly and electrically connected to the circuit assembly, and the grounding member is connected to the housing and located between the conductive members.

In some embodiments, the grounding member has a protruding structure, a grounding portion, and a slot, the protruding structure and the grounding portion extend in a first direction and are exposed to the same side of the base, wherein the slot is formed between the protruding structure and the grounding portion, and the first direction is perpendicular to the optical axis.

In some embodiments, the width of the protruding structure is less than the width of the grounding portion.

In some embodiments, the grounding portion further has two protruding structures and two slots, the grounding portion is located between the protruding structures, and the slots are formed between the protruding structures and the grounding portion.

In some embodiments, the housing includes metal, and the grounding portion is electrically connected to the housing by welding or soldering.

In some embodiments, the driving mechanism further includes a circuit assembly disposed on the base, wherein the movable part has a first protruding portion and a second protruding portion, the first and second protruding portions are located on opposite sides of the movable part and extending in opposite directions that are perpendicular to the optical axis, and the second protruding portion faces the circuit assembly.

In some embodiments, the movable part further has a first protrusion and a second protrusion extending along the optical axis and facing the base, the first protrusion is located below the first protruding portion, and the second protrusion is located below second protruding portion.

In some embodiments, the movable part further has a third protrusion and a fourth protrusion extending along the optical axis, and the first, second, third, and fourth protrusions are located on different sides of the movable part.

In some embodiments, the area of the first protrusion is greater than the area of the second protrusion.

In some embodiments, the area of the second protrusion is greater than the area of the third protrusion.

In some embodiments, the shape of the first protrusion is different from the shape of the second protrusion.

In some embodiments, the driving mechanism further includes a magnet disposed on the movable part and a magnetic field sensor disposed on the circuit assembly for detecting the displacement of the magnet.

In some embodiments, the driving mechanism further includes a thermal glue, wherein the second protruding portion forms a recess for receiving the magnet, and the thermal glue is disposed at the bottom of the recess for adhering the magnet to the movable part.

In some embodiments, the driving mechanism further includes a light-curable adhesive covering the magnet and the recess, wherein the magnet is located between the thermal glue and the light-curable adhesive.

In some embodiments, the light-curable adhesive protrudes from the second protruding portion.

In some embodiments, the base has a column extending along the optical axis. There is a cavity formed on the column, and the movable part has a first protruding portion extending into the cavity along a direction perpendicular to the optical axis.

### BRIEF DESCRIPTION OF THE DRAWINGS

The present invention can be more fully understood by reading the subsequent detailed description and examples with references made to the accompanying drawings, wherein:

FIG. 1 shows an exploded view of a driving mechanism 100 in accordance with an embodiment of the invention.

FIG. 2 shows another exploded view of the driving mechanism 100 in FIG. 1.

FIG. 3 shows a perspective diagram of the driving mechanism 100 in FIGS. 1 and 2.

FIG. 4 shows an exploded view of the housing H and the base B before assembly.

FIG. 5 is an exploded view of the base B, the circuit assembly F, and the conductive assembly P.

FIG. 6 is a perspective diagram of the conductive assembly P electrically connected to the circuit assembly F.

FIG. 7 is a side view of the conductive assembly P.

FIG. 8 is a perspective diagram of the base B, the circuit assembly F, and the conductive assembly P after assembly.

FIG. 9 is another perspective diagram of the driving mechanism 100, where the glue G is disposed at the bottom of the base B.

FIG. 10 is a perspective diagram of the driving mechanism 100 with the housing H and the upper sheet spring FS omitted therefrom.

FIG. 11 is a top view of the driving mechanism 100 with the housing H and the upper sheet spring FS omitted therefrom.

FIG. 12 a perspective diagram of the holder LH and the magnet HM after assembly.

FIG. 13 is another perspective diagram of the holder LH and the magnet HM after assembly FIG. 14 a top view of the holder LH.

FIG. 15 is a sectional view of the magnet HM received in the recess R of the holder LH.

FIG. 16 is a schematic diagram showing the light-curable adhesive G2 disposed on the outer surface of the second protruding portion LH2 of the holder LH.

### DETAILED DESCRIPTION OF THE INVENTION

The making and using of the embodiments of the driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

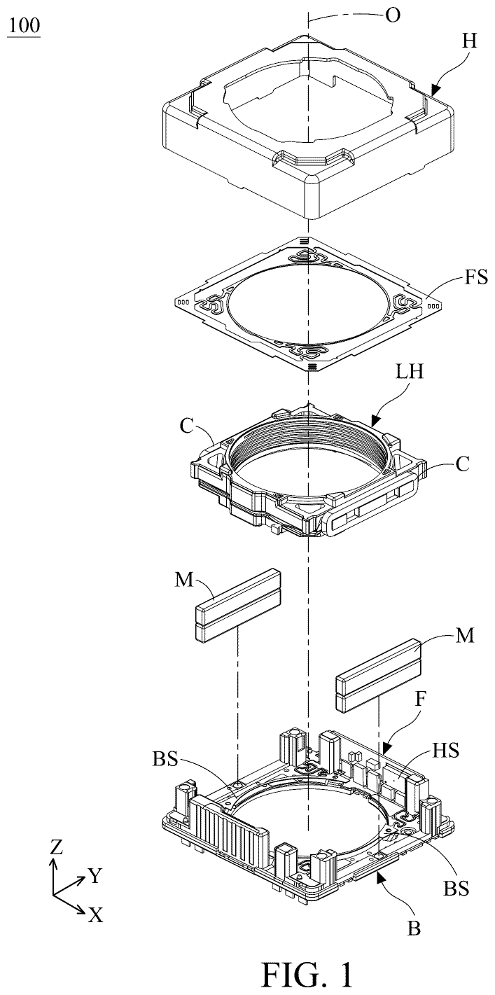

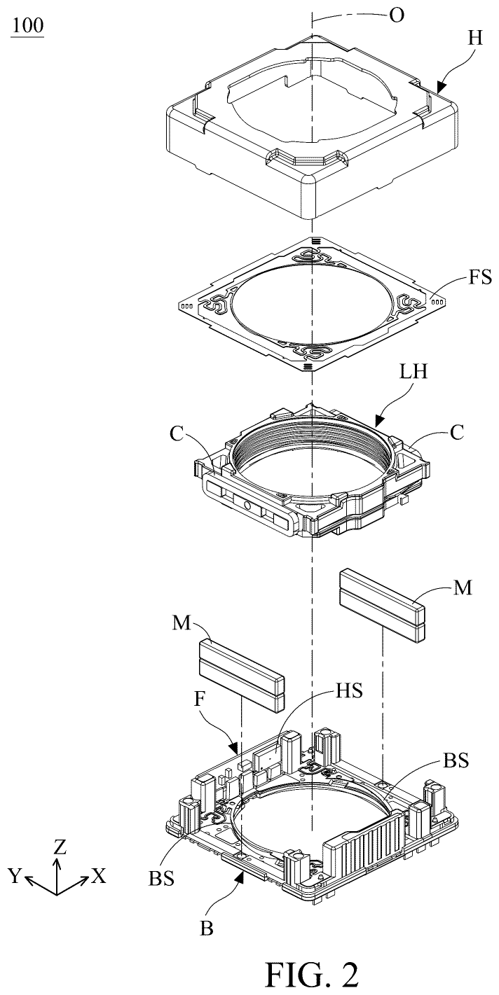

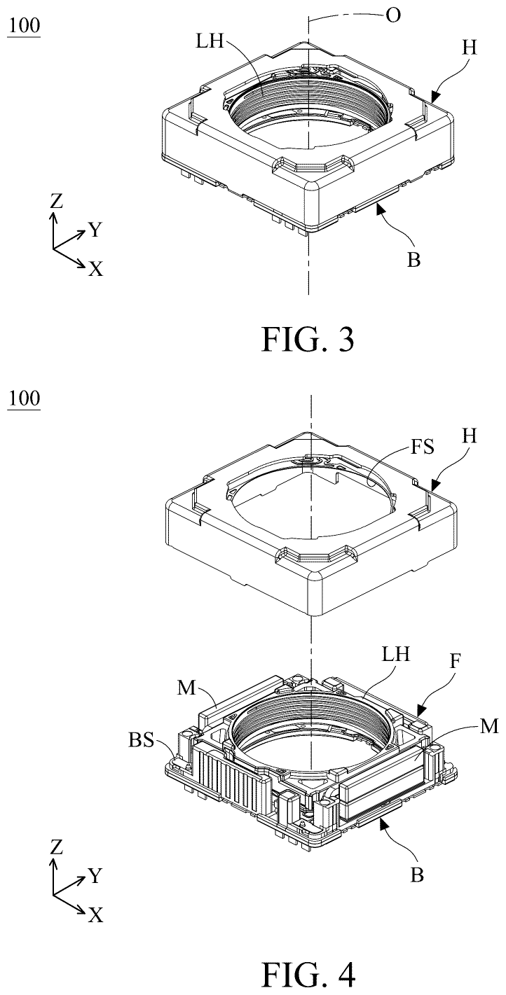

FIG. 1 shows an exploded view of a driving mechanism 100 in accordance with an embodiment of the invention. FIG. 2 shows another exploded view of the driving mechanism 100 in FIG. 1. FIG. 3 shows a perspective diagram of the driving mechanism 100 in FIGS. 1 and 2. FIG. 4 shows an exploded view of the housing H and the base B before assembly.

Referring to FIGS. 1-4, the driving mechanism 100 in this embodiment is a Voice Coil Motor (VCM) which may be disposed in a cell phone or other portable electronic device for driving an optical element (e.g. optical lens) to move, thereby achieving the function of auto-focusing (AF) or Optical Image Stabilization (OIS).

The driving mechanism 100 primarily comprises a hollow housing H, a plastic base B, a circuit assembly F, a holder LH, an upper sheet spring FS, at least a lower sheet spring BS, at least a magnetic element M, and at least a coil C. In this embodiment, the housing H has a hollow structure affixed to the base B. Here, the housing H and the base B form a fixed part of the driving mechanism 100, and the circuit assembly F is affixed to a side of the base B.

Additionally, the holder LH is movably received in the housing H, and an optical element (not shown) is affixed in the holder LH. The holder LH forms a movable part that is movable relative to the fixed part (the housing H and the base B).

The holder LH is connected to the housing H and the base B via the upper and lower sheet springs FS and BS, so that the holder LH can be suspended within the driving mechanism 100. With the configuration as described above, external light can enter the driving mechanism 100 substantially along the optical axis O of the optical element, and light can propagate through the optical element to an image sensor (not shown) below the base B to form a digital image.

It should be noted that two oval-shaped coils C are disposed on opposite sides of the holder LH. Moreover, two magnetic elements M (e.g. magnets) are disposed on the inner sides of the housing H and located corresponding to the coils C. The coils C and the magnetic elements M constitute a driving assembly for impelling the movable part (the holder LH) relative to the fixed part (the housing H and the base B) along the optical axis O.

When a current signal is applied to the coils C, an electromagnetic force can be generated by the coils C and the magnets M, so that the holder LH and the optical element received therein can be driven to move relative to the fixed part (the housing H and the base B) along the optical axis O (Z direction). Hence, the function of auto-focusing (AF) or Optical Image Stabilization (OIS) can be achieved.

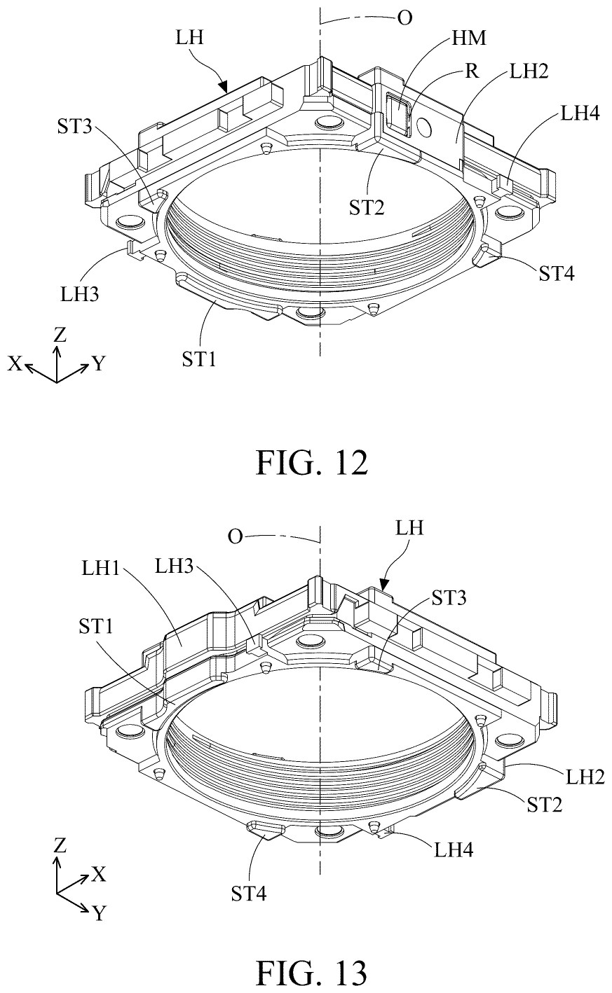

FIGS. 1 and 2 further show a magnetic field sensor HS disposed on the circuit assembly F. Moreover, a magnet HM is disposed on a side of the movable part LH (FIG. 12) and located corresponding to the magnetic field sensor HS. It should be noted that the magnetic field sensor HS may be a Hall effect sensor, MR sensor, or Fluxgate sensor to detect the position variation of the magnet HM, so that the relative displacement between the holder LH and the fixed part (the housing H and the base B) can be determined.

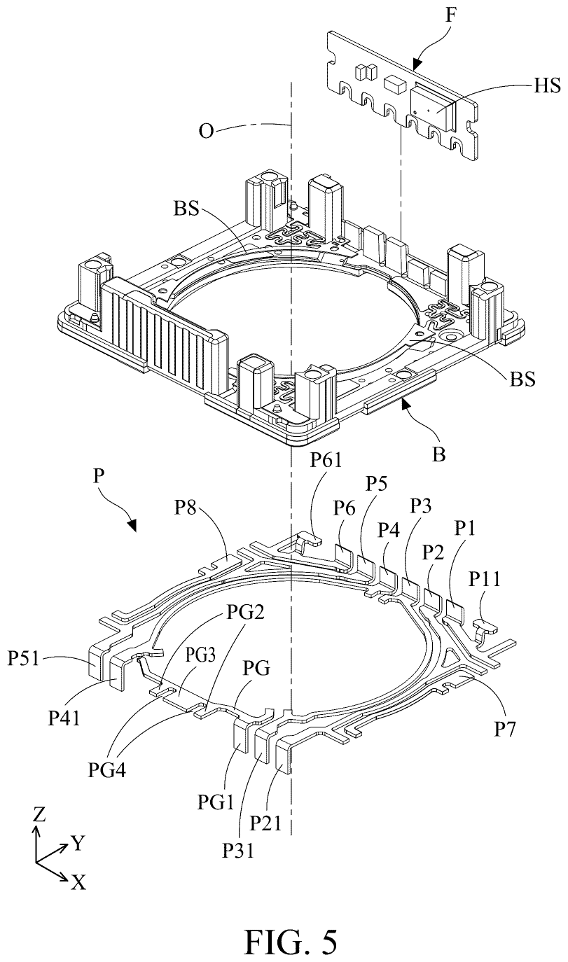

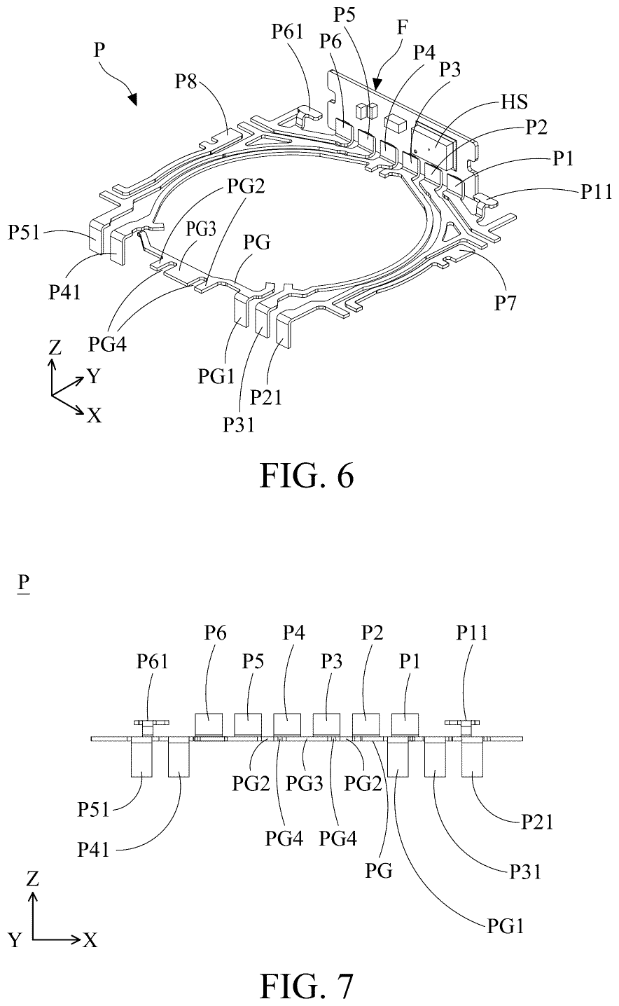

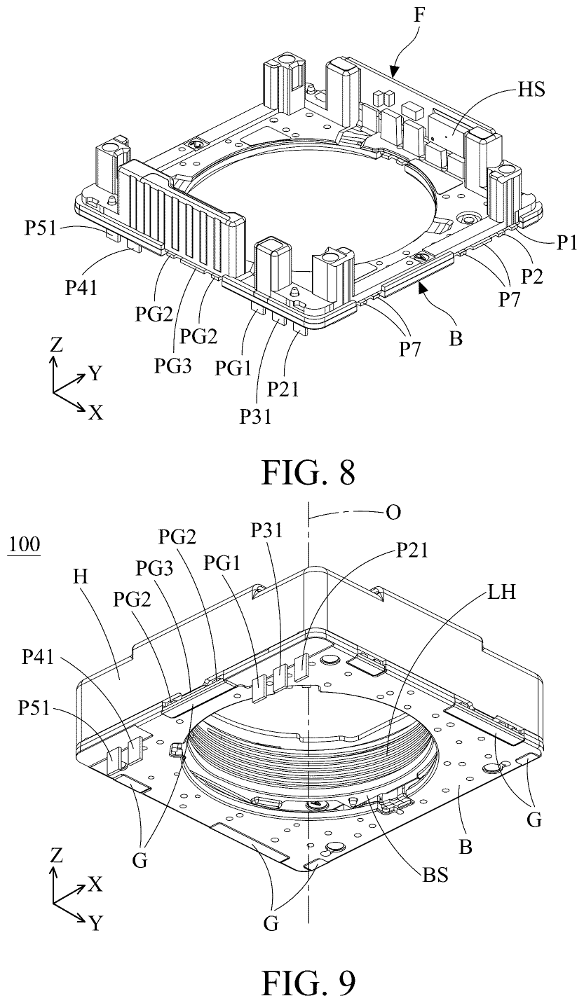

FIG. 5 is an exploded view of the base B, the circuit assembly F, and the conductive assembly P. FIG. 6 is a perspective diagram of the conductive assembly P electrically connected to the circuit assembly F. FIG. 7 is a side view of the conductive assembly P. FIG. 8 is a perspective diagram of the base B, the circuit assembly F, and the conductive assembly P after assembly. FIG. 9 is another perspective diagram of the driving mechanism 100, where the glue G is disposed at the bottom of the base B.

Referring to FIGS. 5-9, the base B has a quadrilateral structure, and the conductive assembly P is embedded in the base B. In this embodiment, the conductive assembly P includes several conductive members P1-P6, two supports P7-P8, and a grounding member PG, which comprise metal and are embedded in the plastic base B by insert molding. It should be noted that the ends of the conductive members P1-P6, the supports P7-P8, and the grounding member PG are exposed to different sides of the base B.

The conductive members P1-P6 are directly and electrically connected to the circuit assembly F. Two flat portions P11 and P61 are respectively formed at the ends of the conductive members P1 and P6. The flat portions P11 and P61 are substantially perpendicular to the optical axis O and exposed to the top side of the base B for electrical connection to the two lower sheet springs BS above the base B. Here, the flat portions P11 and P61 are located higher than the grounding member PG.

As shown in FIG. 9, the ends P21-P51 of the conductive members P2-P5 protrude from the bottom side of the base B and extend in the −Z directions for electrical connection to an external circuit.

Still referring to FIGS. 5-9, the grounding member PG is located between the ends P31-P41 of the conductive members P3 and P4. The grounding member PG has an end portion PG1, at least a protruding structure PG2, a grounding portion PG3, and at least a slot PG4. The protruding structure PG2 and the grounding portion PG3 extend in the −Y direction (first direction). The end portion PG1 extend in the −Z direction and protrude from the bottom side of the base B (FIG. 9).

The slot PG4 is formed between the protruding structure PG2 and the grounding portion PG3. The protruding structure PG2 may be used to connect the metal strip (not shown) in the mold, and it can be cut off from the metal strip after the plastic base B is formed.

During assembly, the grounding portion PG3 may be electrically connected to the metal housing H by welding or soldering, whereby the electronic components inside the driving mechanism 100 can be shielded by the housing H. The protruding structure PG2 and the grounding portion PG3 are spaced apart from each other by the slot PG4. Specifically, the width of the protruding structure PG2 is less than the width of the grounding portion PG3 along the X direction (second direction).

In this embodiment, the grounding portion PG has two protruding structures PG2, and the grounding portion PG3 is located between the two protruding structures PG2. The protruding structures PG2 and the grounding portion PG3 are exposed to the same side of the base B (FIG. 8).

It can be seen in FIG. 9 that the glue G is disposed at the bottom of the base B to protect the conductive members P1-P6, the supports P7-P8, and the grounding member PG during assembly of the driving mechanism 100. The base B and the housing H can be adhered to each other by the glue G to enhance the structural strength and reliability of the driving mechanism 100

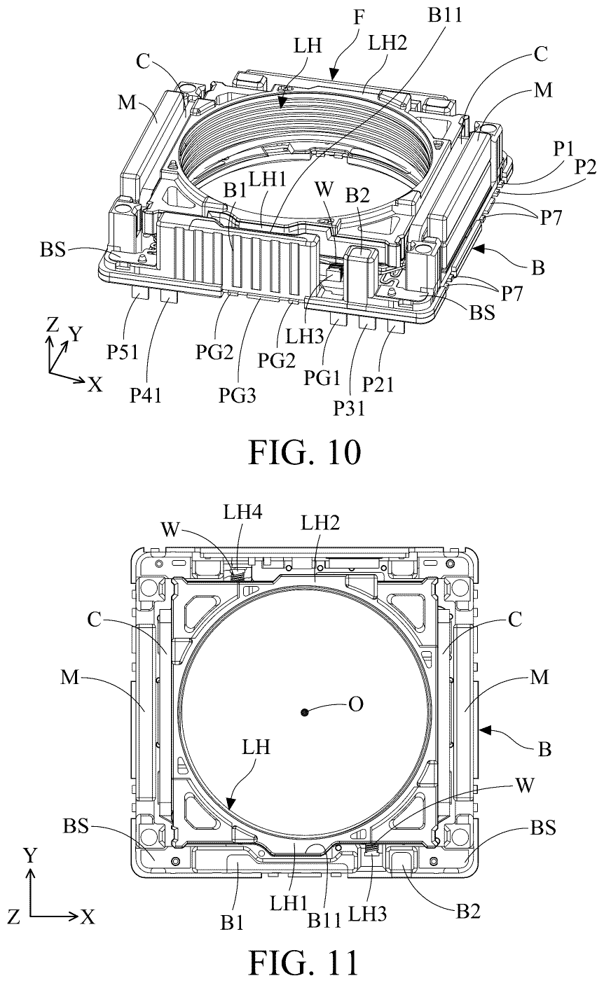

FIG. 10 is a perspective diagram of the driving mechanism 100 with the housing H and the upper sheet spring FS omitted therefrom. FIG. 11 is a top view of the driving mechanism 100 with the housing H and the upper sheet spring FS omitted therefrom.

Referring to FIGS. 10 and 11, the holder LH has a first protruding portion LH1 that extends in the −Y direction, a second protruding portion LH2 that extends in the Y direction, and two bobbins LH3 and LH4. The first and second protruding portions LH1 and LH2 are located on opposite sides of the holder LH, wherein the second protruding portion LH2 face the circuit assembly F, and the bobbins LH3 and LH4 are located adjacent to the first and second protruding portions LH1 and LH2.

In this embodiment, two wires W are connected to the coils C and wound on the bobbins LH3 and LH4. During assembly, the lower sheet springs BS are connected to the wires W on the bobbins LH3 and LH4 by soldering or welding. Hence, the coils C can be electrically connected to the external circuit via the conductive members P1 and P6.

It should be noted that the bobbin LH3 protrudes from the holder LH in the −Y direction (first direction), and is located between two columns B1 and B2 of the base B, thus achieving miniaturization of the driving mechanism 100. Here, the columns B1 and B2 extend along the optical axis O (Z direction), wherein the bobbin LH3 and the columns B1 and B2 at least partially overlap when viewed in the X direction (second direction) that is perpendicular to the optical axis O and the −Y direction (first direction).

Moreover, as shown in FIGS. 10 and 11, a cavity B11 is formed on the inner side of the column B1, and the first protruding portion LH1 of the holder LH extends into the cavity B11. Therefore, when the driving mechanism 100 is impacted by external forces, the holder LH can be prevented from collision with the components inside the driving mechanism 100 due to excessive displacement or rotation of the holder LH.

FIG. 12 a perspective diagram of the holder LH and the magnet HM after assembly. FIG. 13 is another perspective diagram of the holder LH and the magnet HM after assembly. FIG. 14 a top view of the holder LH.

Referring to FIG. 12, the holder LH has a quadrilateral structure. A magnet HM is affixed in a recess R formed on the second protruding portion LH2 of the holder LH. The magnetic field sensor HS on the circuit assembly F can detect the position variation of the magnet HM, so that the displacement of the holder LH relative to the fixed part (the housing H and the base B) can be determined.

As shown in FIGS. 12 and 13, the holder LH has a first protrusion ST1, a second protrusion ST2, a third protrusion ST3, and a fourth protrusion ST4. The first and second protrusions ST1 and ST2 protrude from the bottom side of the holder LH in the −Z direction that is parallel to the optical axis O. The first protrusion ST1 is located directly below the first protruding portion LH1, and the second protrusion ST2 is located directly below the second protruding portion LH2. The third and fourth protrusions ST3 and ST4 are located on opposite sides of the holder LH, and the first, second, third, and fourth protrusions ST1, ST2, ST3, and ST4 are located on different sides of the holder LH and face the base B.

It can be seen in FIG. 14 that the shape of the first protrusion ST1 is different from the shape of the second protrusion ST2, and the shapes of the first and second protrusions ST1 and ST2 are different from the shapes of the third and fourth protrusions ST3 and ST4. In this embodiment, the area of the first protrusion ST1 is greater than the area of the second protrusion ST2, the area of the second protrusion ST2 is greater than the area of the third protrusion ST3, and the area of the second protrusion ST2 is also greater than the area of the fourth protrusion ST4.

As mentioned above, the first and second protrusions ST1 and ST2 are located directly below the first and second protruding portions LH1 and LH2 and extending in the −Z direction. Moreover, the first, second, third, and fourth protrusions ST1, ST2, ST3, and ST4 are located on different sides of the holder LH. Therefore, when the driving mechanism 100 is impacted by an external force, the first, second, third, and fourth protrusions are ST1, ST2, ST3, and ST4 can contact the base B to prevent the optical element in the holder LH from collision with the base B. Moreover, with the first and second protrusions ST1 and ST2 directly formed below the first and second protruding portions LH1 and LH2, the contact area between the holder LH and the base B can be increased, and the structural damage of the holder LH when collided with the base B can also be avoided.

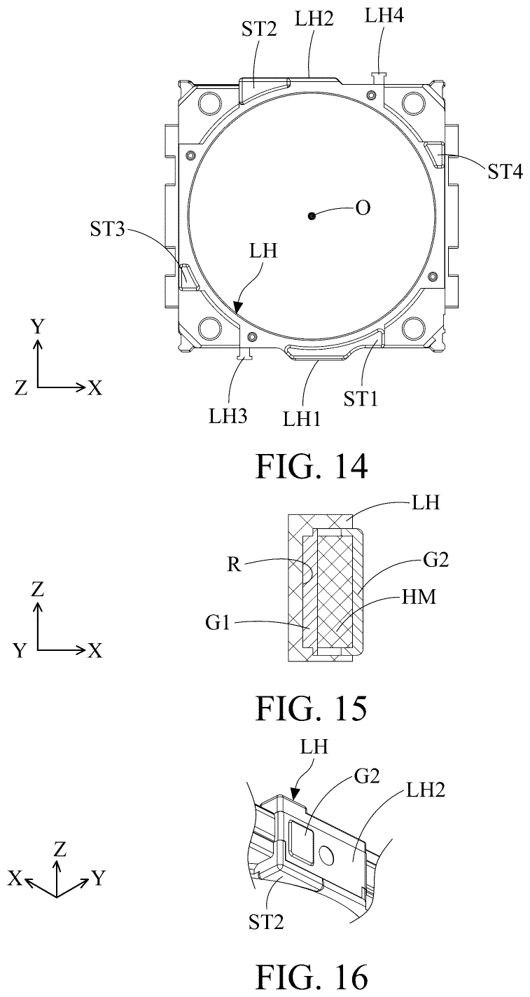

FIG. 15 is a sectional view of the magnet HM received in the recess R of the holder LH. FIG. 16 is a schematic diagram showing the light-curable adhesive G2 disposed on the outer surface of the second protruding portion LH2 of the holder LH.

Referring to FIGS. 15 and 16, during assembly of the driving mechanism 100, the thermal glue G1 can be applied at the bottom of the recess R, and the magnet HM is then disposed in the recess R of the second protruding portion LH2 of the holder LH. Subsequently, the light-curable adhesive G2 (e.g. UV glue) can be disposed on the outer surface of the second protruding portion LH2 of the holder LH to cover the opening of the recess R. Hence, the magnet HM can be covered by the light-curable adhesive G2 that slightly protrudes from the outer surface of the second protruding portion LH2, wherein the magnet HM is located between the thermal glue G1 and the light-curable adhesive G2 after assembly.

As mentioned above, the thermal glue G1 can be disposed at the bottom of the recess R, and the magnet HM is then disposed in the recess R to contact the thermal glue G1. Subsequently, the light-curable adhesive G2 is disposed on the outer surface of the second protruding portion LH2. In this configuration, the light-curable adhesive G2 can be cured by exposure to UV light from the outside of the holder LH, thus preventing the magnet HM from separation from the recess R. Moreover, all the components of the driving mechanism 100 can be heated together for thermal curing after they are assembled, whereby the thermal glue G1 is solidified. Hence, the stepwise curing of the driving mechanism 100 can be accomplished to enhance the structural reliability.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification.

As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A driving mechanism for moving an optical element that has an optical axis, the driving mechanism comprising:
a fixed part;
a movable part, movably connected to the fixed part for holding the optical element; and
a driving assembly, configured for moving the movable part relative to the fixed part.

2. The driving mechanism as claimed in claim 1, further comprising a plurality of conductive members and a grounding member, wherein the fixed part includes a housing and a base connected to each other, the conductive members and the grounding member are embedded in the base, and the grounding member is electrically connected to the housing.

3. The driving mechanism as claimed in claim 2, wherein the conductive members and the grounding member are embedded in the base by insert molding.

4. The driving mechanism as claimed in claim 2, further comprising a lower sheet spring movably connecting the base to the movable part, wherein at least one of the conductive members forms a flat portion that is exposed to a top side of the base and electrically connected to the lower sheet spring, and the flat portion is higher than the grounding member.

5. The driving mechanism as claimed in claim 2, wherein the base has a plurality of columns extending along the optical axis, and the movable part has a bobbin extending in a direction perpendicular to the optical axis and located between the columns.

6. The driving mechanism as claimed in claim 2, further comprising a circuit assembly disposed on the base, wherein the conductive members are directly and electrically connected to the circuit assembly, and the grounding member is connected to the housing and located between the conductive members.

7. The driving mechanism as claimed in claim 6, wherein the grounding member has a protruding structure, a grounding portion, and a slot, the protruding structure and the grounding portion extend in a first direction and are exposed to the same side of the base, wherein the slot is formed between the protruding structure and the grounding portion, and the first direction is perpendicular to the optical axis.

8. The driving mechanism as claimed in claim 7, wherein the width of the protruding structure is less than the width of the grounding portion.

9. The driving mechanism as claimed in claim 7, wherein the grounding portion further has two protruding structures and two slots, the grounding portion is located between the protruding structures, and the slots are formed between the protruding structures and the grounding portion.

10. The driving mechanism as claimed in claim 7, wherein the housing comprises metal, and the grounding portion is electrically connected to the housing by welding or soldering.

11. The driving mechanism as claimed in claim 2, further comprising a circuit assembly disposed on the base, wherein the movable part has a first protruding portion and a second protruding portion, the first and second protruding portions are located on opposite sides of the movable part and extending in opposite directions that are perpendicular to the optical axis, and the second protruding portion faces the circuit assembly.

12. The driving mechanism as claimed in claim 11, wherein the movable part further has a first protrusion and a second protrusion extending along the optical axis and facing the base, the first protrusion is located below the first protruding portion, and the second protrusion is located below second protruding portion.

13. The driving mechanism as claimed in claim 12, wherein the movable part further has a third protrusion and a fourth protrusion extending along the optical axis, and the first, second, third, and fourth protrusions are located on different sides of the movable part.

14. The driving mechanism as claimed in claim 13, wherein the area of the first protrusion is greater than the area of the second protrusion.

15. The driving mechanism as claimed in claim 14, wherein the area of the second protrusion is greater than the area of the third protrusion.

16. The driving mechanism as claimed in claim 13, wherein the shape of the first protrusion is different from the shape of the second protrusion.

17. The driving mechanism as claimed in claim 11, further comprising a magnet disposed on the movable part and a magnetic field sensor disposed on the circuit assembly for detecting the displacement of the magnet.

18. The driving mechanism as claimed in claim 17, further comprising a thermal glue, wherein the second protruding portion forms a recess for receiving the magnet, and the thermal glue is disposed at the bottom of the recess for adhering the magnet to the movable part.

19. The driving mechanism as claimed in claim 18, further comprising a light-curable adhesive covering the magnet and the recess, wherein the magnet is located between the thermal glue and the light-curable adhesive.

20. The driving mechanism as claimed in claim 19, wherein the light-curable adhesive protrudes from the second protruding portion.

21. The driving mechanism as claimed in claim 2, wherein the base has a column extending along the optical axis and a cavity is formed on the column, and the movable part has a first protruding portion extending into the cavity along a direction perpendicular to the optical axis.
